(19) United States
(12) Patent Application Publication
(10) Pub. No.: US 2006/0181514 A1
(43) Pub. Date: Aug. 17, 2006

(54) Providing input data

(76) Inventor: Andrew Newman, Enfield (GB)

Correspondence Address: Anthony G. Fussner, Suite 400, 7700 Bonhomme, St. Louis, MO, 63105, US

(21) Appl. No.: 11/355,228

(22) Filed: Feb. 15, 2006

(30) Foreign Application Priority Data
Feb. 17, 2005 (GB) 05 03 291.7

(51) Int. Cl. G09G 5/00

(52) U.S. Cl. 345/168

(57) ABSTRACT

A manually operable data input device is constructed from fabric and is configured to receive input data from a user. A low power consumption radio transmitting device is interfaced to the input device for transmitting input data. A radio receiving device receives transmitted input data and conveys this to a data processing device. The radio transmitting device may transmit data to the receiving device in accordance with the ZigBee protocol or the IEEE 802.15.4 protocol. The data processing device can be a computer, a laptop computer, a hand-held computer, a personal digital assistant, audio player, mobile cellular telephone, satellite telephone, image recorder, a voice recorder, a microcontroller, and/or a systems control processor.

### CROSS-REFERENCE TO RELATED APPLICATION

This application claims priority to United Kingdom Patent Application No. 05 03 291.7, filed 17 Feb. 2005, the entire disclosure of which is incorporated herein by reference in its entirety as if fully set forth herein.

### FIELD

The present invention relates to apparatus for providing data input, having a data processing device configured to produce an output signal. The present invention also relates to a method of supplying data to a laptop computer.

### BACKGROUND

The statements in this section merely provide background information related to the present disclosure and may not constitute prior art.

Keyboards and other input devices are used with laptop computers. For example, a laptop computer usually includes a keyboard for inputting data into the laptop computer.

### SUMMARY

According to an aspect of the present invention, there is provided a manually operable data input device constructed from fabric and configured to receive input data from a user; a low power consumption radio transmitting device is interfaced to the input device for transmitting input data; a radio receiving device receives transmitted input data and conveys this to a data processing device.

In various embodiments, the radio transmitting device may transmit data to the receiving device in accordance with the ZigBee protocol or the IEEE 802.15.4 protocol. The data processing device may be a computer, a laptop computer, a hand-held computer, a personal digital assistant, audio player (e.g., MP3 player, etc.), mobile cellular telephone, satellite telephone, image recorder, a voice recorder, a microcontroller, and/or a systems control processor.

Further aspects and features of the present disclosure will become apparent from the detailed description provided hereinafter. In addition, any one or more aspects of the present disclosure may be implemented individually or in any combination with any one or more of the other aspects of the present disclosure. It should be understood that the detailed description and specific examples, while indicating exemplary embodiments of the present disclosure, are intended for purposes of illustration only and are not intended to limit the scope of the present disclosure.

### DRAWINGS

The drawings described herein are for illustration purposes only and are not intended to limit the scope of the present disclosure in any way.

FIG. 1 shows a manually operable fabric keyboard;

FIG. 2 shows the inner workings of the fabric keyboard shown in FIG. 1;

FIG. 3 shows details of an electronic processing device of the type shown in FIG. 2;

FIG. 4 illustrates a radio environment;

FIG. 5 illustrates an application of the radio environment shown in FIG. 4;

FIG. 6 shows a keyboard of the type identified in FIG. 1 implemented as a sun visor;

FIG. 7 shows a fabric keyboard forming part of the outer surface of a bag or sack;

FIG. 8 shows a fabric keyboard forming part of soft furnishing;

FIG. 9 shows a fabric key input device fabricated as part of a soft toy;

FIG. 10 illustrates a fabric device forming a strap for a wristwatch;

FIG. 11 shows a fabric device forming part of a jacket or vest;

FIG. 12 shows a jacket having a manually operable device for controlling mobile devices;

FIG. 13 shows a wireless fabric switch for controlling lighting; and

FIG. 14 shows an alternative configuration for the switches identified in FIG. 13.

### DETAILED DESCRIPTION

The following description is merely exemplary in nature and is in no way intended to limit the present disclosure, application, or uses.

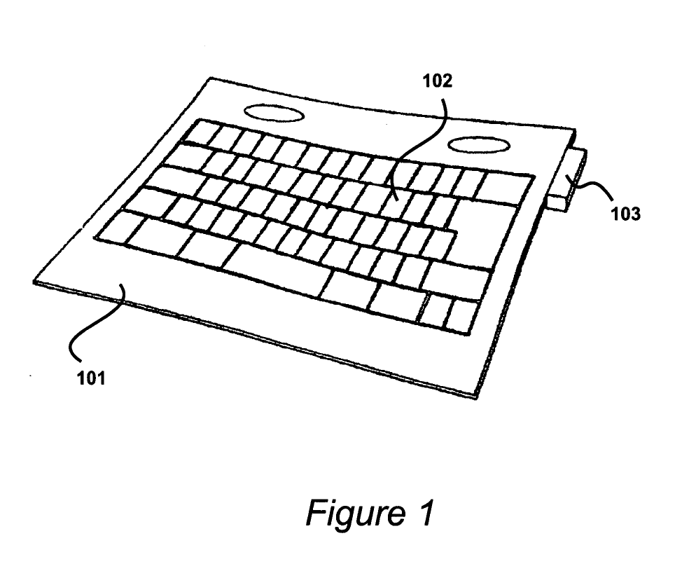

A manually operable data input device is illustrated in FIG. 1 embodied as a fabric keyboard. Flexible fabric keyboards are known, as illustrated in U.S. Pat. No. 6,861,961, assigned to the present assignee. The keyboard is constructed substantially from fabric 101 and has key positions 102 printed thereon. An electronic interface device 103 identifies positions at which keys have been depressed and from this produces output data identifying an alphanumeric character. The electronic processing device 103 includes a low power consumption radio transmitting device interfaced such as to transmit input data received in response to key presses. The radio transmitting device is arranged to transmit radio signals to a radio receiving device arranged to receive the transmitted input data.

In an embodiment, the radio transmitting device transmits data to the receiving device in accordance with the ZigBee protocol (an implementation of the IEEE 802.15.4 protocol), Bluetooth, or other appropriately configured radio transmission protocol.

As previously stated, the radio receiving device supplies input data to a data processing device. The data processing device may take the form of a computer, a laptop computer, a handheld computer, a personal digital assistant, an audio player (such as an MP3 player), a mobile cellular telephone, a satellite telephone, an image recorder (such as a digital camera), a voice recorder, a microcontroller, and/or a systems control processor for example.

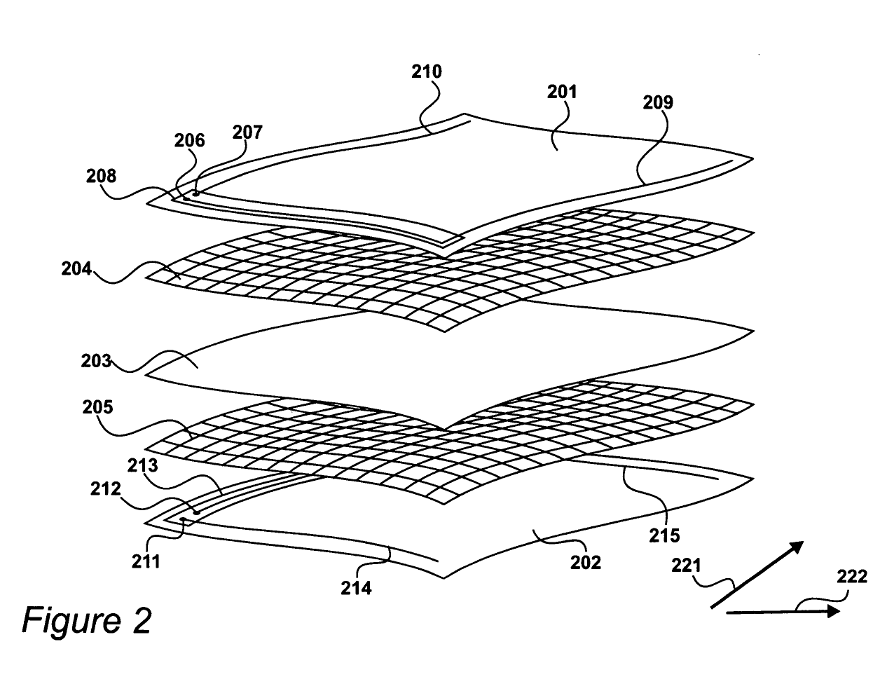

Inner workings of a fabric keyboard illustrated in FIG. 1 are shown in FIG. 2. Outer fabric layers 201 and 202 are separated by a central layer 203. Each of layers 201 to 203 is electrically conductive, established by combining insulating fibers with electrically conducting fibers. A first insulating mesh layer 204 is located between the upper fabric layer 201 and the central layer 203. In addition, a second insulating mesh layer 205 is located between the lower fabric layer 202 and the central layer 203. Two electrical connectors 206 and 207 are located on a rectangular insulating stripe 208 that is positioned along one edge of fabric layer 201. The insulating stripe is produced by printing insulating ink onto the fabric or by applying insulating adhesive tape. The connectors 206 and 207 provide a means of connecting the electronic processing device 103 to lower resistance elements 209 and 210, respectively. The lower resistance elements 209 and 210 are fabricated from fabric coated with metals such as nickel or silver, and the lower resistance elements are attached to the conductive fiber layers and the insulating strips by conductive adhesive, such as a pressure sensitive acrylic adhesive containing metallized particles.

The lower fabric layer 202 has a similar construction to the upper fabric layer 201, having connectors 211 and 212 located on an insulating stripe 213. The connectors 211 and 212 provide means for connecting the electronic processing device 103 with low resistance elements 214 and 215 respectively.

When a key press occurs, the insulating layers 204 and 205 are compressed such that electrical conduction is possible through the conducting layers 201, 203 and 202. By applying a potential across the lower layer and measuring a voltage at the upper layer a potential divider is created and it is possible to determine a position of the interaction in the direction of arrow 221. Thereafter, by reversing the process and applying a voltage across the upper layer and detecting a voltage in the lower layer it is possible to determine a position of the interaction in the direction of arrow 222. These two positions then define the position of the interaction on the two-dimensional plane of the keyboard, from which it is possible to identify the specific key that has been pressed.

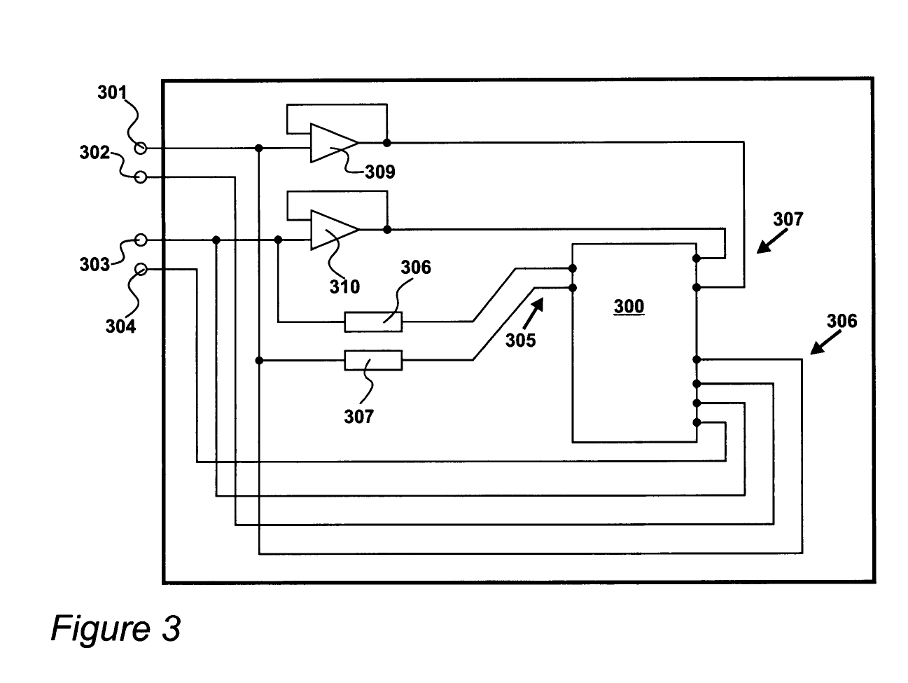

Electronic processing device 103 is detailed in FIG. 3. The processing device includes a wireless microcontroller. This may be an IEEE 802.15.4 wireless controller, such as the JN5121 produced by Jennic of Furnival Street, Sheffield, United Kingdom. The microcontroller is a low power IEEE 802.15.4 compliant wireless microcontroller combining an on chip 23 bit RISC core and a fully compliant 2.4 gigahertz IEEE 802.15.4 transceiver, along with 64 kilobytes of ROM and 96 kilobytes of RAM.

The processing device supplies voltages to connectors 301, 302, 303, and 304 and provides output values for radio transmission. Resistors 306 and 307 have a resistance that is substantially similar to the resistance of the fabric detector measured from a first conducting layer 201 to the other conducting layer 202 when a typical target pressure has been applied; values in the region of 10 k ohm are typical for these resistors.

A detection process is controlled by a program executed by the microcontroller that is in turn configured to supply output voltages at pins 305 and 306 and to receive analogue voltages at pins 307. Input pins 307 receive outputs from high impedance buffers 309 and 310, typically being operational amplifiers of type TL062 operating at half unity gain to provide a high impedance buffer between the output voltages and the microcontroller input ports.

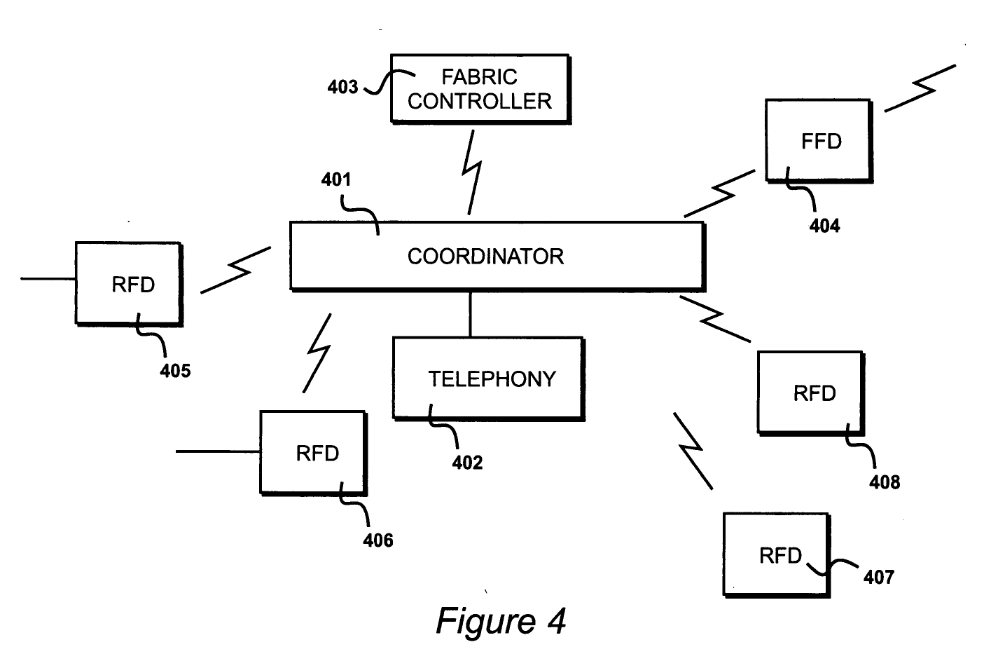

An IEEE 802.15.14 ZigBee environment is illustrated in FIG. 4. At the heart of the network, there is provided a ZigBee coordinator 401, which, in turn, operates under the control of a local computer system for performing data processing operations. The coordinator provides a bridge to other networks, such as a telephony network 402. It is also the place where information about the network itself is stored.

The fabric keyboard or controller illustrated in FIG. 1 is shown as 403 in FIG. 4 and communicates wirelessly with the coordinator 401. A full function device (FFD) 404 may act as an intermediate router and allows data to be passed from other devices. Reduced function devices (RFDs) 405 to 408 are also provided within the network.

The ZigBee network uses the IEEE 802.15.4 low rate wireless personal area network standard to describe its lower protocol layers, namely the physical layer and the medium access control portion of the data link layer. In this embodiment, wireless operation takes place at 2.4 gigahertz using DSSS which is managed by the digital stream into the modulator. An orthogonal signaling scheme is used that transmits four bits per symbol in the 2.4 gigahertz band to provide a raw over-the-air data rate of 250 kilobytes per channel in the 2.4 gigahertz band. Transmission range is typically between 10 meters and 75 meters. The channel mode access specified by IEEE 802.15.4 is carrier sense, multiple access such that nodes briefly check to see that no one else is transmitting before they themselves start transmitting.

The coordinator 401 is a data processing device configured to produce an output signal. Thus, an output signal may be provided to an application program executed by a local computing facility such that data is received within an operational package, such as a spreadsheet or an email program for example. Alternatively, the data processing device may produce an output signal to a wider network, such as that provided by the telephony functionality 402.

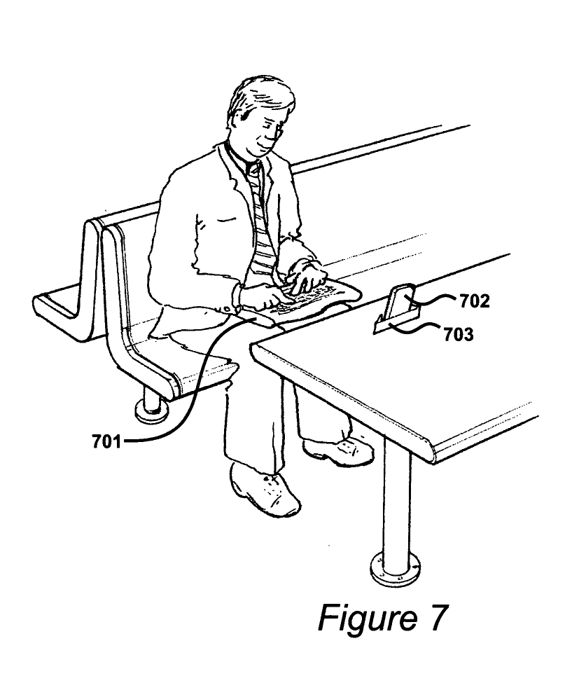

A manually operable data input device constructed from fabric is configured to receive input data from a user. In the example described so far, the input device takes the form of an alphanumeric keyboard but it should be appreciated that other input devices may be used (such as an alpha pad, a numeric key pad, an audio player controller, a telephone interface, and/or an input interface for an image recorder). Further examples are described with reference to FIGS. 7 to 12.

The IEEE 802.15.14 radio environment and specifically when using the ZigBee protocol provides a low power consumption radio transmitting device that is interfaced to the input device for transmitting input data. Thus, the fabric controller 403 includes the fabric keyboard device as illustrated in FIG. 1 interfaced to an appropriate node such as a full function device of the type shown at 404. At the coordinator 401, there is provided a radio receiving device for receiving the transmitted input data such that the radio receiving device is interfaced to the data processing device.

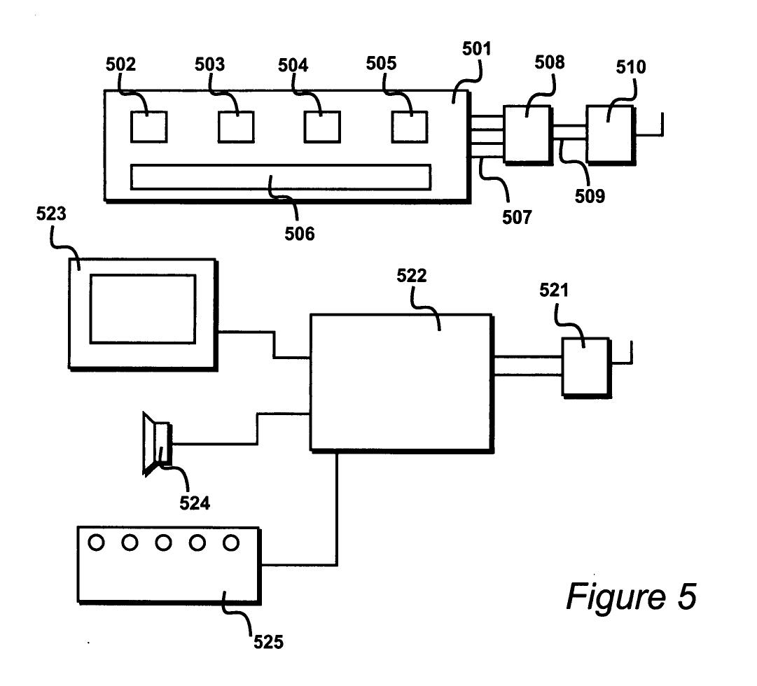

A schematic representation of an application is illustrated in FIG. 5. A manually operable data input device 501 is constructed from fabric. This may take the form of a keyboard of the type illustrated in FIG. 1 or an alternative configuration of responsive areas may be deployed. In the example shown in FIG. 5, the manually operable input device includes four areas 502 to 505 that are responsive to a mechanical interaction to perform a switching operation. Thus, upon applying pressure to a region, such as region 502, a logical “on” condition is established whereafter a further application of pressure to that region will revert the condition to a logical “off”; the switch performing a simple toggle operation. Thus, each of regions 502 to 505 may be used to control a specific function operating in an on or off manner.

It should be appreciated that within the region of the active fabric of device 501, the actual functionality provided will be determined by control software. Thus, in this example region 506 operates in an alternative manner. Region 506 is responsive to movement such that finger pressure may be applied to a part of the region whereafter the finger is moved while remaining in pressure. This movement is detected and may in turn be used to control variable parameters, such as a volume control or the physical movement of an actuator for example. Four analogue wires 507 from the fabric device are interfaced to a control circuit 508 as previously described. Control circuit 508 produces a digital output signal on a bus 509 to a low power consumption radio transmitting device 510, such that the radio transmitting device is interfaced to the input device 501 via control circuit 508.

In this example, the radio transmitting device 510 transmits data in accordance with the ZigBee protocols, as detailed above, such that data produced by the input device 501 is received at a radio receiving device 521. The radio receiving device 521 is interfaced to a data processing device 522 programmed so as to respond to input data commands. As previously stated, the actual nature of the data processing device 522 may take many forms and to illustrate this output, signals are shown being supplied to a visual output device 523, an audio output device 524, and a mechanical control device 525. Thus, in response to the input device 501, text data may be generated and displayed on the visual display 523. Alternatively, operations may result in media items being selected for display on device 523. Similarly, audio media may be supplied to audio output device 524 or the device may be used to produce alarm signals for example. Control system 525 may be used to control industrial processors or to control equipment in a domestic environment, for example.

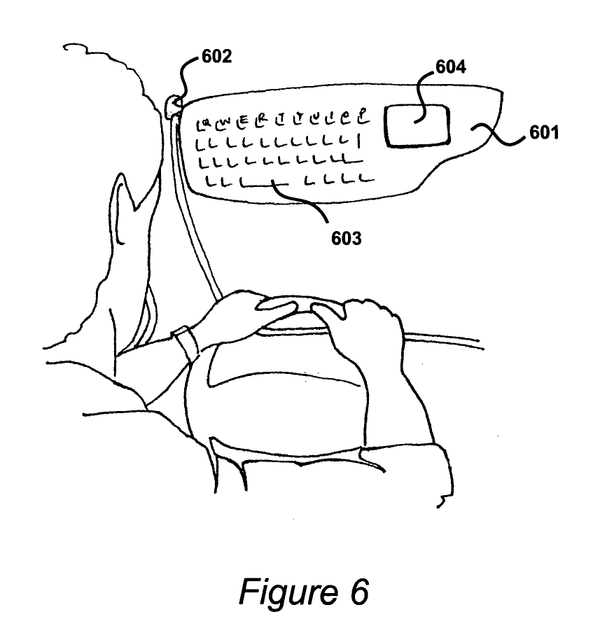

A driver of a motor vehicle is illustrated at FIG. 6, in a driving position with vision shielded from the sun by a sun visor 601. The sun visor 601 may pivot on a mount 602 (as is known) from a folded away storage position into a lowered sun-shading position. The mount 602 is configured such that the sun visor 601 may be easily detached. The mount is also configured as an electrical plug and the sun visor 601 incorporates an electrical socket such that, for example, two connection poles are available providing zero volts and plus 12 volts DC power to the sun visor when attached to the mount 602. The sun visor 601 incorporates an alphanumeric keyboard 603 of the type substantially similar to that previously described. The keyboard device is constructed integrally with the sun visor so as to provide lightness and durability while not distracting from its primary function of shielding sunlight.

When mounted as shown in FIG. 6, keyboard functionality is disabled and radio communication devices are permanently placed in a sleep mode. However, when detached, the communication devices are activated such that it is then possible for keyboard operation to take place and for input data to be supplied to a local coordinator over the radio network. In this way, the keyboard would operate within the local vicinity of the motor vehicle. However, communication could be provided over wider networks in response to coordinator 401 establishing a telephony call via telephony circuitry 402. It is also appreciated that other wireless enabled devices could exist within the motor vehicle so as to facilitate operations relating to vehicle position, vehicle maintenance, traffic conditions and to the operation of supplementary functional entities.

In some embodiments, the sun visor could also be provided with a visual screen 604. In some operational situations, it is possible that the keyboard could operate while retained in its sun visor orientation as illustrated in FIG. 6. However, should this condition be required, it is likely that operation would not occur while the vehicle was in use and activation of the keyboard could be initiated upon activation of the handbrake. Alternatively, the keyboard could be provided at a passenger location and operation of the keyboard could be allowed while vehicle motion takes place. However, under such circumstances, it is envisaged that operation would be facilitated by the removal of the visor.

With a wireless protocol network established within the motor vehicle, it is also possible that this network could communicate with a house enabled network as soon as the motor vehicle becomes within range.

The keyboard device includes rechargeable batteries such that these batteries are recharged when the sun visor is relocated as illustrated in FIG. 6.

As an alternative to being fabricated as a stand-alone fabric keyboard, the fabric keyboard can be included as part of a bag or sack. An example is shown in FIG. 7 in which the keyboard has been incorporated onto the outer surface of a bag 701 for carrying a laptop computer. In some embodiments, the bag could be for carrying a tablet or other device. In this way, it is possible for a user to conduct a degree of data processing without removing a laptop computer from its bag, activating the laptop computer and waiting for the computer to load its programs and, possibly, establish network communication. The application is particularly attractive to users on the move who may have short periods of time to wait while wishing to be productive. A typical example would include waiting at airports where passengers tend to be moved from one location to another, sometimes only waiting for short and often unpredictable, periods of time. Thus, in many of these situations it can be inconvenient to remove a laptop computer and it can be frustrating if the laptop computer then has to be put back into its bag before any productive work has commenced.

In this example, the bag itself includes the manually operable data input device in the form of a fabric keyboard configured to receive input data from the user. The bag includes a low power consumption radio transmitting device such that data input received may be transmitted and then received by other devices. The user may therefore wish to construct an email (effectively a string of text) which can then be incorporated within an application program when the laptop computer is operational, without actually activating the laptop computer at this point in time.

In order for the user to obtain feedback in response to key presses, radio communication is established with a portable display device 702, such as a mobile telephone or a PDA. The portable display device 702 may be supported by a stand 703, such as that as illustrated in British patent application no. 05 26 161.5, assigned to the present assignee. Thus, in this way, it is possible for a text string to be created (for subsequent transmission as a text message or as an email for example) using the personal computer (possibly after performing editing operations using the laptop computer) without actually activating the laptop computer or removing it from bag 701.

In this example, the laptop computer itself also includes radio capability. Processing devices forming part of the bag 701 also include a cache such that, in addition to the data being displayed by device 702, the data is also retained in the cache forming part of the bag 701. When an associated computer is detected, usually the laptop computer contained within the bag 701, this condition is also detected by the bag electronics such that a transfer of data takes place and, possibly, the cache is flushed. Thus, in this way, it is possible for a user to generate data that may be manipulated within the laptop computer and used for laptop computer based applications. However, when appropriate, this data may be created without removing the computer from its bag or even activating the computer in any way. A user would, for example, simply remove a mobile telephone from a pocket, appropriately position it and then establish communication via the fabric keyboard components fabricated onto the outer surface of the bag itself.

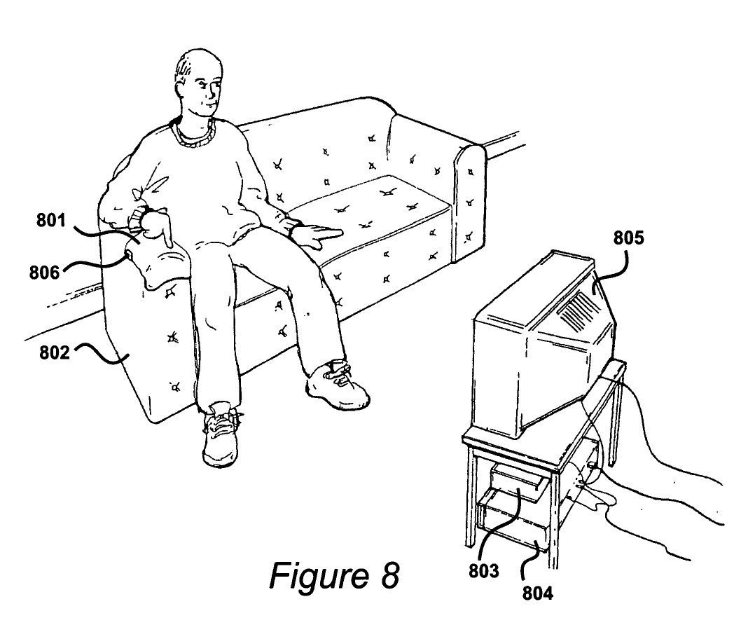

As previously stated, the manually operable data input device may take alternative configurations in addition to that of an alphanumeric keyboard. As illustrated in FIG. 8, a device 801 has been located over an arm of a sofa 802 in a household environment. Alternatively it could be located over a chair or over any other soft furnishing.

In this embodiment, the device is being used to control audio and/or video entertainment apparatus. The low power consumption of the device ensures that operation is available for a significant period, easily compatible with the battery life of known infrared devices for example.

A data processing device 803 is provided that is configured to produce an output signal for controlling the operation of an audio device 804 and a television set 805. Manually operable data input device 801 is constructed from fabric and is configured to receive input data from a user. A low power consumption radio transmitting device 806 is interfaced to the input device for transmitting the input data. A radio receiving device is provided for receiving the transmitted input data and a radio receiving device is interfaced to the data processing device. Thus, in this way, it is possible for any device within the household environment to be controlled from a manually operable data input device. Furthermore, the input device is substantially made from fabric such that it may be removed from the radio transmitting device so as to be washed or easily replaced, when damaged or when wishing to modify the aesthetic appearance.

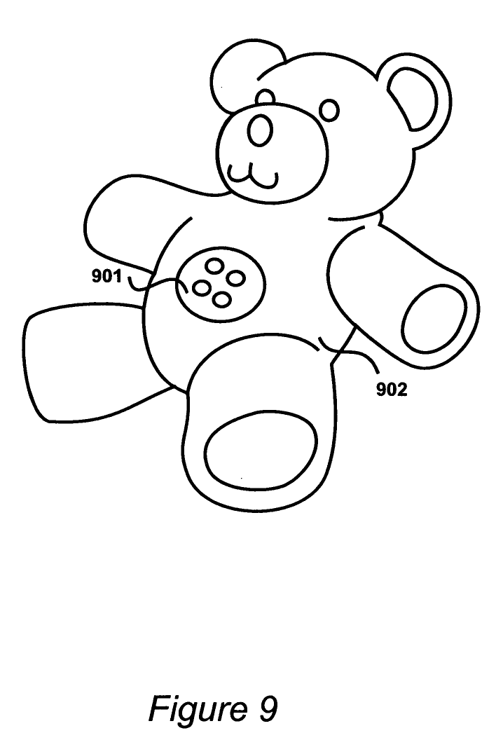

An alternative embodiment for use within a household environment is illustrated in FIG. 9. On this occasion, a manually operable input device 901 is incorporated within a soft toy 902. In this way, over the radio network, it is possible for the soft toy to be used to control devices in a fashion similar to that described with respect to FIG. 8. Alternatively, the controls may be used to allow interaction with a computer program, possibly an educational program, in which there is a logical interplay between the nature of the physical toy and a representation of the toy within a computer generated environment.

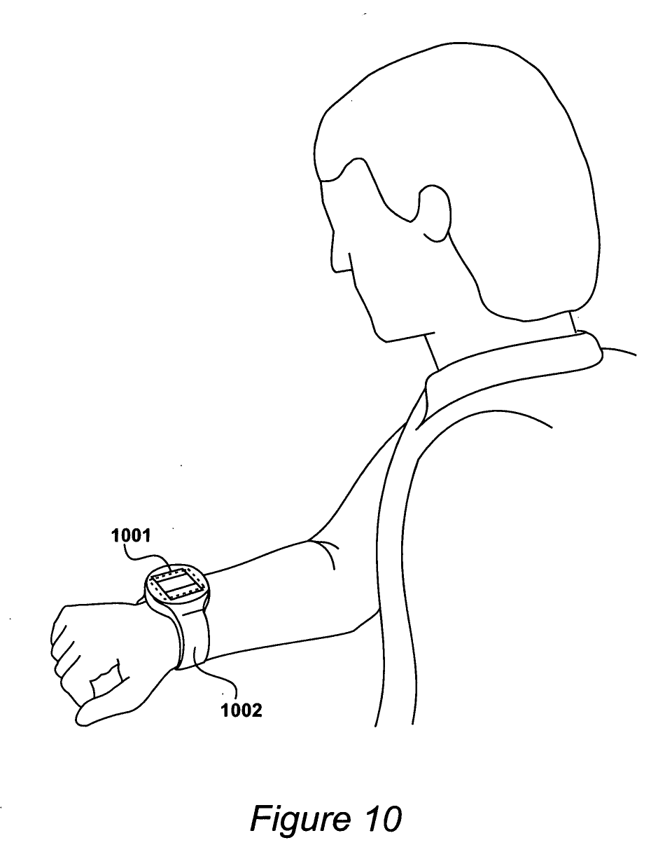

An alternative embodiment is shown in FIG. 10 in which the manually operable data input device constructed from fabric takes the form of a strap 1001 for a wristwatch 1002. Alternatively, without the wristwatch, a similar configuration could take the form of a bracelet or a wristband. The functionality of the wrist-strap 1001 may be provided in addition to and independent from the activity of the watch itself or the functionality maybe combined. Thus, in one embodiment, the wrist-strap 1001 provides a surface upon which user input may take place while the electronics and power supply are provided within the wristwatch 1002 itself. Furthermore, radio communication could be facilitated by the inclusion of conductive materials within the strap of the wristwatch, providing or facilitating the functionality of an antenna.

The manually operable data input device constructed from fabric may be incorporated into other wrist or hand devices, such as a glove.

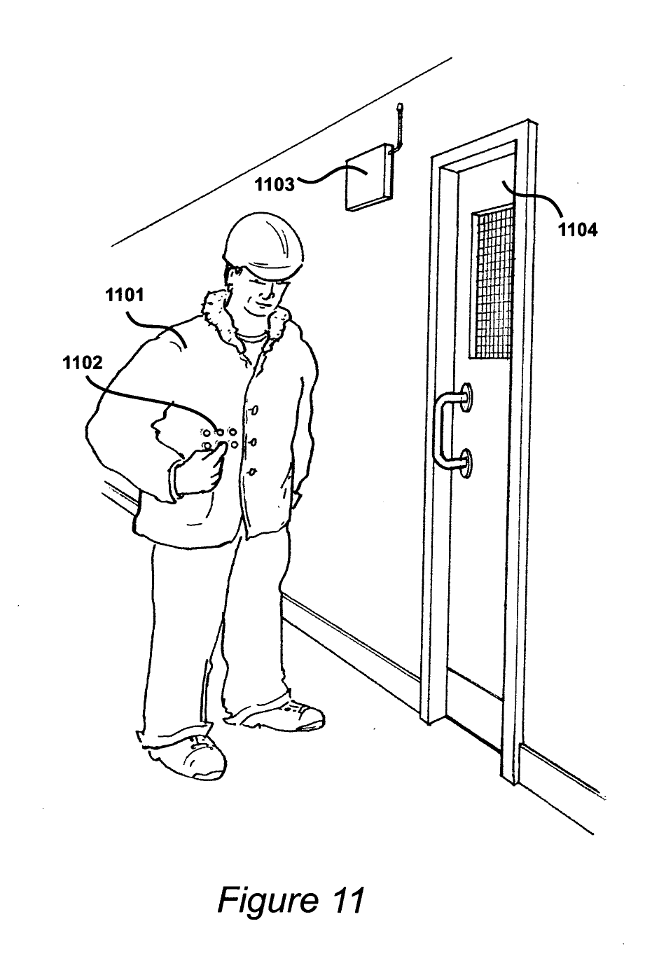

An alternative embodiment is illustrated in FIG. 11 in which the manually operable data input device constructed from fabric is included as part of an over-jacket or vest 1101. In this way, the vest 1101 includes a region 1102 that includes fabric input devices. These input devices are interfaced to a low power consumption radio-transmitting device for transmitting the input data. A radio-receiving device 1103 is located within a building or factory workshop so as to receive the transmitted input data. This received data is then conveyed to data processing devices allowing appropriate actions to be taken.

In this way, workers could be provided with vests of the type shown at 1101 allowing each of them to be provided with appropriate control devices for controlling the operation of machinery, for example. Thus, in this way, it would be possible for all workers within an environment to be provided with emergency access controls, possibly shutting down a process should an emergency condition exist. Thus, controls of this type are always readily available and it is not necessary to move to a particular location where physical buttons are provided. Similarly, with such devices, overall efficiency could be improved in that again control devices are provided locally to each operative without the operatives being required to make specific manual operations.

Jackets of this type could also be useful within security applications and could, for example, be used to track the location of operatives within hazardous environments. Again in security applications, the input device could be used to specify access codes when an operative wishes to make progress through a secure door 1104. Similarly, being wireless enabled, each jacket could have a specific embedded unique identification reference and a further level of security could be provided by the manual application of an identification number. Thus, a user would be given a specific jacket (with a known access code) and a user would then be given a particular access code such that a user would only be given access when wearing the allocated jacket and when the access code was known.

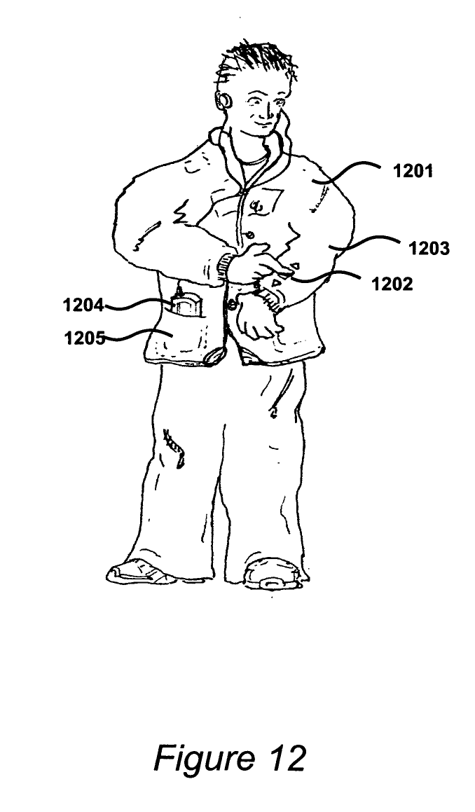

An alternative embodiment is illustrated in FIG. 12 in which a jacket 1201 (such as a jacket suitable for sports activities for example) is provided with a manually operable data input device 1202 fabricated on the arm 1203 of the jacket. Again, the manually operable data input device (constructed from fabric) is configured to receive input data from a user, this time in a form appropriate for controlling a mobile device. A low power consumption radio transmitting device is included with the data input device and at a separate location on the jacket the radio receiving device is provided for receiving the transmitted input data, whereupon the radio receiving device is interfaced to a data processing device. In this example, the radio data processing device takes the form of an audio player (such as an MP3 player) 1204 located in an external pocket 1205. Alternatively, the MP3 or other audio player could be located in an internal pocket of the jacket or located anywhere on the user's person; there being no requirement to provide a physical communication path between the input device 1202 and the MP3 player 1204.

It is established that the ZigBee protocol is an appropriate network for establishing a wireless light switch environment within a commercial or residential building. In this embodiment, a switch wakes up when activated and thereafter sends a command to a lamp, receives an acknowledgement back to the effect that the lamp has been activated, and then returns to its sleep mode. The switch node is typically a reduced function device (RDF), such as RFD 405 illustrated in FIG. 4.

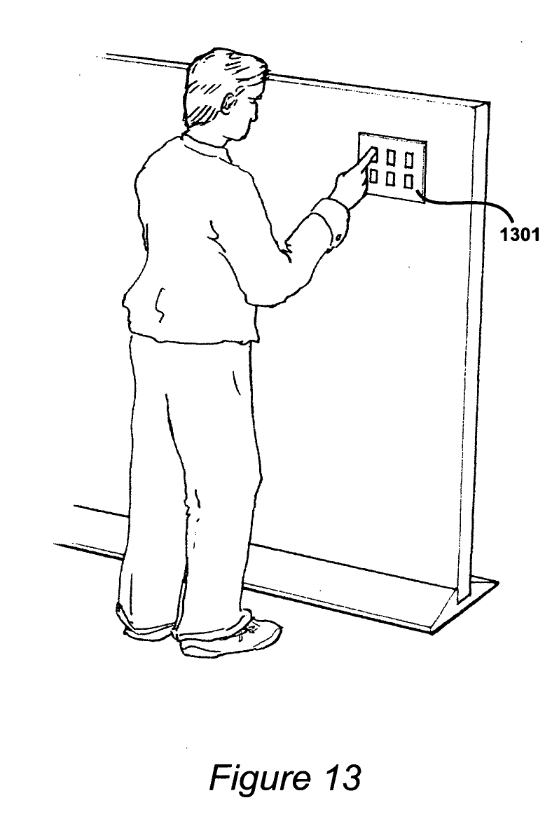

In an example shown in FIG. 13, a switch array 1301 provides a manually operable data input device constructed from fabric and configured to receive input data from a user. In this example, the fabric defines six light switch regions, although the actual number of switch regions provided would be determined by the application. Many more switches could be included and the technology also facilitates the use of gesticulative operations which could, for example, provide the functionality of a light dimmer. A switch is therefore associated with a low power consumption radio transmitting device for transmitting the input data. The radio receiving device is provided at a data processing device which in turn controls the activation of the lights, possibly by energizing the relay.

It should be appreciated that by providing fabric light switches, their construction is simple and inexpensive. Thus, as shown in FIG. 13 a particular arrangement of six light switches is provided in a two by three matrix.

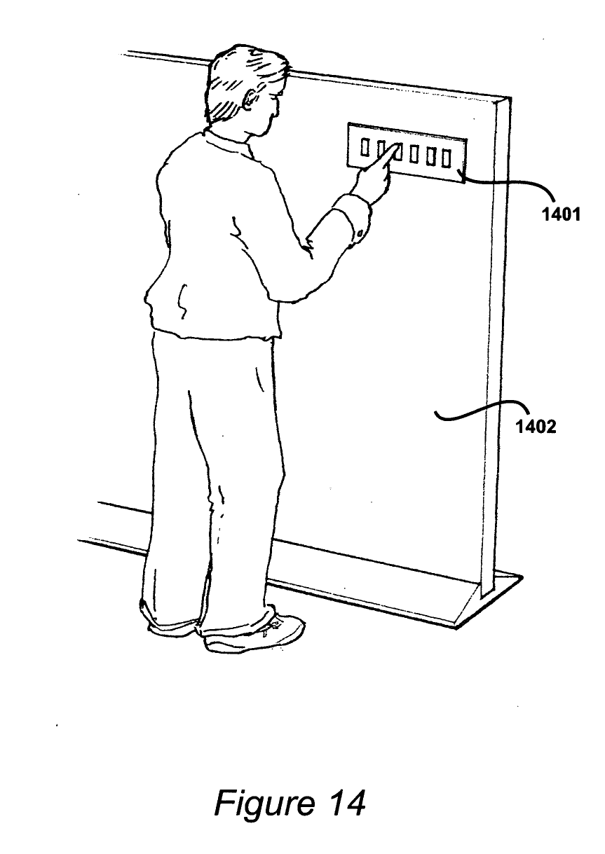

During renovation, the switch configuration of FIG. 13 is easily replaced as illustrated in FIG. 14 where again, six light switches are provided but this time in a one by six array 1401. Similarly, the color scheme of the fabric light switch could be changed or modified to include indicia, such as corporate logos, for example. Thus, during renovation or decoration the light switches are merely discarded and replaced with new fabric light switches, with the control functionality remaining in place but out of sight.

A light switch of this type is also very attractive when deployed in environments with non-permanent walls, such as wall 1402. In this way, walls and dividers can be rearranged and light switches applied wherever it is considered appropriate for them to be applied. Thus, in some situations, traditional lighting switches are appropriately positioned for an open plan environment. However, as an open plan office becomes divided, the position of a light switch may be far from ideal and it would be preferable if the light switch could be located locally, possibly on a temporary screen or wall. In the present embodiment, the light switch is merely removed from one position and relocated at another position, possibly using easily detachable fasteners, such as Velcro® or other types of hook and loop fasteners.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order or performance. It is also to be understood that additional or alternative steps may be employed.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. Apparatus for providing data input, comprising:
a data processing device configured to produce an output signal;
a manually operable data input device constructed from fabric and configured to receive input data from a user;
a low power consumption radio transmitting device interfaced to the input device for transmitting the input data; and
a radio receiving device for receiving the transmitted input data, wherein the radio receiving device is interfaced to the data processing device.

2. Apparatus according to claim 1, wherein the radio-transmitting device transmits data to the radio receiving device in accordance with the ZigBee protocol or the IEEE 802.15.4 protocol.

3. Apparatus according to claim 1, wherein the data processing device comprises at least one of:
a computer;
a laptop computer;
a hand-held computer; a personal digital assistant;
an audio player;
a mobile cellular telephone;
a satellite telephone;
an image recorder;
a voice recorder;
a microcontroller; and
a systems control processor.

4. Apparatus according to claim 1, wherein the input device comprises at least one of:
a numeric key pad;
an alphanumeric keyboard;
an audio player controller;
an alpha pad;
a telephone interface; and
an input interface for an image recorder, a voice recorder, a microcontroller, or a systems control processor.

5. Apparatus according to claim 1, wherein the input device forms part of a sun visor for a motor vehicle, wherein the sun visor is configured to be releasably connected to a motor vehicle.

6. Apparatus according to claim 5, wherein the input device is operable when released from the motor vehicle.

7. Apparatus according to claim 6, wherein the input device comprises rechargeable batteries, and wherein the rechargeable batteries are recharged when the input device is connected to a motor vehicle.

8. Apparatus according to claim 5, further comprising a visual display.

9. Apparatus according to claim 1, wherein the input device is incorporated on a surface of a personal bag or sack.

10. Apparatus according to claim 9, wherein the input device comprises an alphanumeric keyboard on the outside of a bag for carrying a mobile computer.

11. Apparatus according to claim 10, configured to display data to a user by means of a mobile phone or a personal digital assistant (PDA) while receiving input data.

12. Apparatus according to claim 10, configured to cache data until an associated computer is within active range, whereafter the cached input data is transmitted to the computer.

13. Apparatus according to claim 1, wherein the input device forms part of a soft furnishing.

14. Apparatus according to claim 13, wherein the data processing device is configured to present entertainment content to a user.

15. Apparatus according to claim 1, wherein the input device is incorporated within a soft toy.

16. Apparatus according to claim 1, wherein the input device is incorporated within a wrist or hand device.

17. Apparatus according to claim 1, wherein the input device forms part of an item of clothing.

18. Apparatus according to claim 17, wherein the input device is used to control a processing device also included with the item of clothing, or is used to control a device external to the item of clothing.

19. Apparatus according to claim 1, wherein the input device is attachable to a wall and defines a plurality of switches for controlling at least one of lighting and heating within an area.

20. Apparatus according to claim 19, wherein the input device is readily removed and replaced to facilitate re-decoration of a room defining the area.

21. Apparatus for controlling an audio player, comprising:
a manually operable data input device constructed from fabric, wherein the input device is configured to receive input data from a user and forms part of an item of clothing;
a low power consumption radio transmitting device interfaced to the input device for transmitting control data; and
a radio receiving device interfaced to the audio player for receiving the transmitted control data and controlling the audio player.

22. A bag for holding a laptop, tablet, or other computing device having a fabric alphanumeric keyboard on a surface, comprising:
a data processing device connected to the keyboard and configured to produce a first output signal for visual display and a second delayed output signal;
a low power consumption radio transmitting device interfaced to the data processing device, and configured to:
(a) transmit the first output signal to a mobile telephone or to a personal digital assistant (PDA) for display purposes;
(b) cache input data received from the keyboard; and
(c) transmit the second delayed output signal by reading the cached input data upon detecting a request to download after the removal and activation of the laptop computer, tablet, or other computing device.

23. A method of supplying data to a laptop computer, comprising:
supporting a laptop computer held within a bag while the laptop computer is in a non-operational state;
manually operating keys defined by a fabric keyboard forming part of the bag;
viewing input data interactively by a radio connected mobile device;
caching the input data; and
downloading the cached input data to the laptop computer after the laptop computer has been removed from the bag and activated for use.
